(19) United States
(12) Patent Application Publication
(10) Pub. No.: US 2002/0078091 A1
(43) Pub. Date: Jun. 20, 2002

(54) Automatic summarization of a document

(76) Inventors: Sonny Vu, Cambridge, MA (US); Christopher Bader, Medford, MA (US); David Purdy, Somerville, MA (US)

Correspondence Address: FAUSTINO A. LICHAUCO, Fish & Richardson P.C., 225 Franklin Street, Boston, MA, 02110-2804, US

(21) Appl. No.: 09/908,443

(22) Filed: Jul. 18, 2001

Related U.S. Application Data
(60) Provisional application No. 60/220,568, filed on Jul. 25, 2000.

(51) Int. Cl. G06F 17/00

(52) U.S. Cl. 707/513; 707/514

(57) ABSTRACT

A target document having a plurality of features is summarized by collecting contextual data external to the document. On the basis of this contextual data, the features of the target document are then weighted to indicate the relative importance of that feature. This results in a weighted target document that is then summarized.

This invention relates to information retrieval systems, and in particular, to methods and systems for automatically summarizing the content of a target document.

### BACKGROUND

A typical document includes features that suggest the semantic content of that document. Features of a document include linguistic features (e.g. discourse units, sentences, phrases, individual words, combinations of words or compounds, distributions of words, and syntactic and semantic relationships between words) and non-linguistic features (e.g. pictures, sections, paragraphs, link structure, position in document, etc.). For example, many documents include a title that provides an indication of the general subject matter of the document.

Certain of these features are particularly useful for identifying the general subject matter of the document. These features are referred to as “essential features.” Other features of a document are less useful for identifying the subject matter of the document. These features are referred to as “unessential features.”

At an abstract level, document summarization amounts to the filtering of a target document to emphasize its significant features and de-emphasize its unessential features. The summarization process thus includes a filtering step in which individual features comprising the document to be summarized are weighted by an amount indicative of how important those features are in suggesting the subject matter of the document.

### SUMMARY

A major difficulty in the filtering of a target document lies in the determination of what features of the target document are important and what features can be safely discarded. The invention is based on the recognition that this determination can be achieved, in part, by examination of contextual data that is external to the target document. This contextual data is not necessarily derivable from the target document itself and is thus not dependent on the semantic content of the target document.

An automatic document summarizer incorporating the invention uses this contextual data to tailor the summarization of the target document on the basis of the structure associated with typical documents having the same or similar contextual data. In particular, the document summarizer uses contextual data to determine what features of the target document are likely to be of importance in a summary and what features can be safely ignored.

For example, if a target document is known to have been classified by one or more search engines as news, one can infer that that target document is most likely a news-story. Because a news-story is often written so that the key points of the story are within the first few paragraphs, it is preferable, when summarizing a news-story, to assign greater weight to semantic content located at the beginning of the news-story. However, in the absence of any contextual information suggesting that the target document is a news-story, a document summarizer would have no external basis for weighting one portion of the target document more than any other portion.

In contrast, an automatic document summarizer incorporating the invention knows, even before actually inspecting the semantic content of the target document, something of the general nature of that document. Using this contextual data, the automatic document summarizer can adaptively assign weights to different features of the target document depending on the nature of the target document.

In one practice of the invention, a target document having a plurality of features is summarized by collecting contextual data external to the document. On the basis of this contextual data, the features of the target document are then weighted to indicate the relative importance of that feature. This results in a weighted target document that is then summarized.

Contextual data can be obtained from a variety of sources. For example, contextual data can include meta-data associated with the target document, user data associated with a user for which a summary of the target document is intended, or data from a network containing the target document.

In one practice of the invention, a set of training documents, each of the training documents having a corresponding training document summary is maintained. This set of training documents, is used to identify, from the training documents, a document cluster that includes documents similar to the target document. On the basis of training document summaries corresponding to training documents in the document cluster, a set of weights used to generate the training document summaries from the training documents in the document cluster.

These and other features, objects, and advantages of the invention will be apparent from the following detailed description and the accompanying drawings, in which:

### BRIEF DESCRIPTION OF THE DRAWINGS

FIG. 1 illustrates an automatic-summarization system;

FIG. 2 shows the architecture of the context analyzer of FIG. 1;

FIG. 3 shows document clusters in a feature space; and

FIG. 4 a hierarchical document tree.

### DETAILED DESCRIPTION

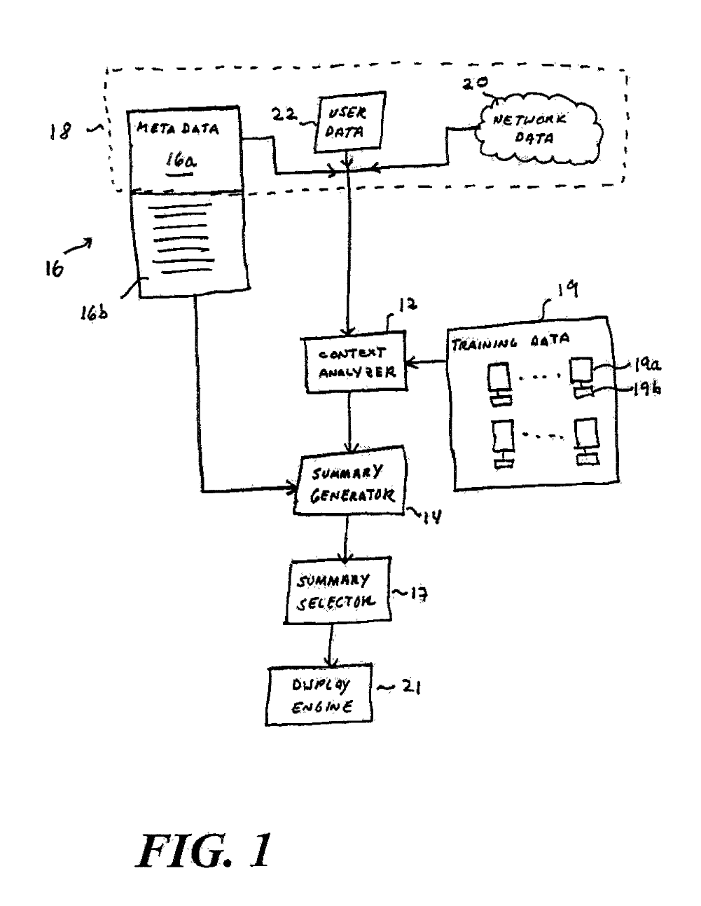

An automatic summarization system 10 incorporating the invention, as shown in FIG. 1, includes a context analyzer 12 in communication with a summary generator 14. The context analyzer 12 has access to: an external-data source 18 related to the target document 16, and to a collection of training data 19.

The external-data source 18 provides external data regarding the target document 16. By definition, data is external to the target document when it cannot be derived from the semantic content of that document Examples of such external data include data available on a computer network 20, data derived from knowledge about the user, and data that is attached to the target document but is nevertheless not part of the semantic content of the target document.

The training data 19 consists of a large number of training documents 19a together with a corresponding summary 19b for each training document. The summaries 19b of the training documents 19a are considered to be of the type that the automatic summarization system 10 seeks to emulate. The high quality of these training-document summaries 19b can be assured by having these summaries 19b be written by professional editors. Alternatively, the training document summaries 19b can be machine-generated but edited by professional editors.

The external data enables the context analyzer 12 to identify training documents that are similar to the target document 16. Once this process, referred to as contextualizing the target document, is complete, the training data 19 is used to provide information identifying those features of the target document 16 that are likely to be of importance in the generation of a summary. This information, in the form of weights to be assigned to particular features of the target document 16, is provided to the summary generator 14 for use in conjunction with the analysis of the target documents text for the generation of a summary of the target document 16. The resulting summary, as generated by the summary generator 14, is then refined by a summary selector 17 in a manner described below. The output of the summary selector 17 is then sent to a display engine 21.

When the target document 16 is available on a computer network 20, such as the Internet, the external-data source 18 can include the network itself. Examples of such external data available from the computer system 20 include:

the file directory structure leading to and containing the target document 16,

the classification of the target document 16 in a topic tree or topic directory by a third-party classification service (such as Yahoo! or the Open Directory Project or Firstgov.gov),

the popularity of the target document 16 or of documents related to the target document 16, as measured by a popularity measuring utility on a web server,

the number of hyperlinks pointing to the target document 16 and the nature of the documents from which those hyperlinks originate,

the size, revision history, modification date, file name, author, file protection flags, and creation date of the target document 16,

information about the document author, obtained, for example, from an internet accessible corporate personnel directory,

the domains associated with other viewers of the target document 16, and

any information available in an external file, examples of which include server logs, databases, and usage pattern logs.

External data such as the foregoing is readily available from a server hosting the target document 16, from server logs, conventional profiling tools, and from documents other than the target document 16.

In addition to the computer network 20, the external-data source 18 can include a user-data source 22 that provides user data pertaining to the particular user requesting a summary of the target document 16. This user data is not derivable from the semantic content of the target document 16 and therefore constitutes data external to the target document 16. Examples of such user data include user profiles and historical data concerning the types of documents accessed by the particular user.

As indicated in FIG. 1, a target document 16 can be viewed as including metadata 16a and semantic content 16b. Semantic content is the portion of the target document that one typically reads. Metadata is data that is part of the document but is outside the scope of its semantic content. For example, many word processors store information in a document such as the documents author, when the document was last modified, and when it was last printed. This data is generally not derivable from the semantic content of the document, but it nevertheless is part of the document in the sense that copying the document also copies this information. Such information, which we refer to as metadata, provides yet another source of document external information within the external-data source 18.

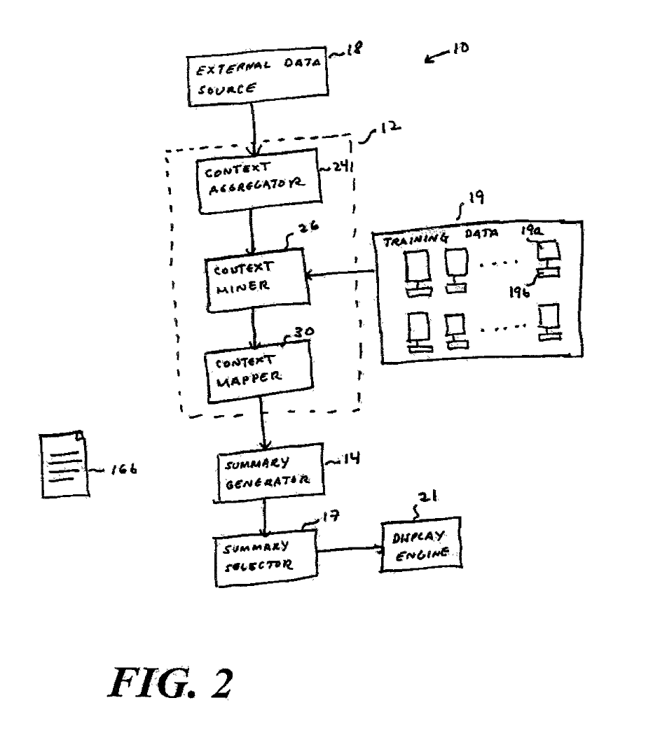

Referring now to FIG. 2, the context analyzer 12 includes a context aggregator 24 having access to the network 20 on which the target document 16 resides. The context aggregator 24 collects external data concerning the target document 16 by accessing information from the network 20 on which the target document 16 resides and inspecting any web server logs for activity concerning the target document 16. This external data provides contextual information concerning the target document 16 that is useful for generating a summary for the target document 16.

In cases in which particular types of external data are unavailable, the context aggregator 24 obtains corresponding data for documents that are similar to the target document 16. Because these documents are only similar and not identical to the target document 16, the context aggregator 24 assigns to external data obtained from a similar document a weight indicative of the similarity between the target document 16 and the similar document.

The similarity between two documents can be measured by graphing similarity distances on a lexical semantic network (such as Wordnet), by observing the structure of hyperlinks originating from and terminating in the documents, and by using statistical word distribution metrics such as term frequency and inverse document frequency (TF.IDF) to provide information indicative of the similarity between two documents.

Known techniques for establishing a similarity measure between two documents are given in Dumais et al., Inductive Learning Algorithms and Representations for Text Categorization, published in the 7th International Conference on Information and Knowledge Management, 1998. Additional techniques are taught by Yang et al., A Comparative Study on Feature Selection and Text Categorization, published in the Proceedings of the 14th International Conference on Machine Learning, 1997. Both of the foregoing publications are herein incorporated by reference.

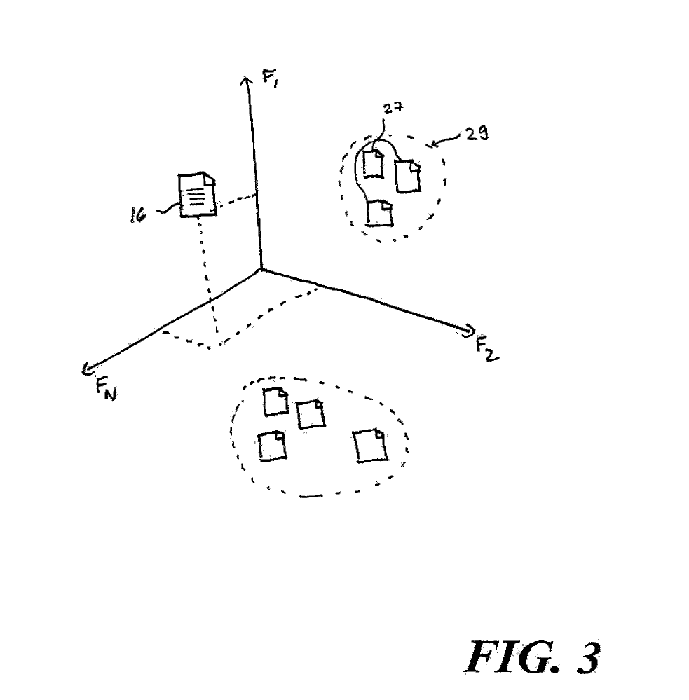

Referring now to FIG. 3, the context aggregator 24 defines a multi-dimensional feature space and places the target document 16 in that feature space. Each axis of this feature space represents an external feature associated with that target document 16. On the basis of its feature space coordinates, the domain and genre of the target document 16 can be determined. This function of determining the domain and genre of the target document 16 is carried out by the context miner 26 using information provided by the context aggregator 24.

The context miner 26 probabilistically identifies the taxonomy of the target document 16 by matching the feature-space coordinates of the target document 16 with corresponding feature-space coordinates of training documents 27 from the training data 19. This can be accomplished with, for example, a hypersphere classifier or support vector machine autocategorizer. On the basis of the foregoing inputs, the context miner 26 identifies a genre and domain for the target document 16. Depending on the genre and domain assigned to the target document 16, the process of generating a document summary is altered to emphasize different features of the document.

Examples of genres that the context miner 26 might assign to a target document 16 include:

a news-story,

a page from a corporate website,

a page from a personal website,

a page of Internet links,

a page containing product information,

a community website page,

a patent or patent application,

a résumé

an advertisement, or

a newsgroup posting.

Typical domains associated with, for example, the news-story genre, include

political stories,

entertainment related stories,

sports stories,

weather reports,

general news,

domestic news, and

international news.

The foregoing genres and domains are exemplary only and are not intended to represent an exhaustive list of all possible genres and domains. In addition, the taxonomy of a document is not limited to genres and domains but can include additional subcategories or supercategories.

The process of assigning a genre and domain to a target document 16 is achieved by comparing selected feature-space coordinates of the target document 16 to corresponding feature-space coordinates of training documents 27 having known genres and domains. The process includes determining the distance, in feature space, between the target document and each of the training documents. This distance provides a measure of the similarity between the target document and each of the training documents. Based on this distance, one can infer how likely it is that the training document and the target document share the same genre and domain. The result of the foregoing process is therefore a probability, for each domain/genre combination, that the target document has that domain and genre.

In carrying out the foregoing process, it is not necessary that the coordinates along each dimension, or axis, of the feature space be compared. Among the tasks of the context miner 26 is that of selecting those feature-space dimensions that are of interest and ignoring the remaining feature-space dimensions. For example, using a support vector machine algorithm, this comparison can be done automatically.

The context miner 26 probabilistically classifies the target document 16 into one or more domains and genres 29. This can be achieved by using the feature space distance between the target document 16 and a training document to generate a confidence measure indicative of the likelihood that the target document 16 and that training document share a common domain and genre.

In classifying the target document 16, the context miner 26 identifies the presence and density of objects embedded in the target document 16. Such objects include, but are not limited to: frames, tables, Java applets, forms, images, and pop-up windows. The context miner 26 then obtains an externally supplied profile of documents having similar densities of objects and uses that profile to assist in classifying the target document 16. Effectively, each of the foregoing embedded objects corresponds to an axis in the multi-dimensional feature space. The density of the embedded object in the target document 16 maps to a coordinate along that axis.

The density of certain types of embedded objects in the target document 16 is often useful in probabilistically classifying that document. For example, using the density of pictures, the context miner 26 may distinguish a product information page, with its high picture density, from a product review, with its comparatively lower picture density. This will likely affect which parts of the target document 16 are weighted as significant for summarization.

In probabilistically classifying the target document 16, the context miner 26 also uses document external data such as: the file directory structure in which the target document 16 is kept, link titles from documents linking to the target document 16, the title of the target document 16, and any contextual information derived from the classification of that target document 16 in databases maintained by such websites as Yahoo, ODP, and Firstgov.gov. In this way, the context miner 26 of the invention leverages the efforts already expended by others in the classification of the target document 16.

Having probabilistically classified the target document 16, the context miner 26 then passes this information to a context mapper 30 for determination of the weights to be assigned to particular portions of the target document 16. The feature vectors of the documents or clusters of documents matching the target document 16 are mapped to weights assigned to the features of the target document 16. The weights for documents in a given cluster can be inferred by examination of training documents within that cluster together with corresponding summaries generated from each of the training documents in that cluster.

In the above context, a cluster is a set of training documents that have been determined, by a clustering algorithm such as k-nearest neighbors, to be similar with respect to some feature space representation. The clustering of the training data prior to classification of a target document, although not necessary for practice of the invention, is desirable because it eliminates the need to compare the distance (in feature space) between the feature space representation of the target document and the feature space representation of every single document in the training set. Instead, the distance between the target document and each of the clusters can be used to classify the target document. Since there are far fewer clusters than there are training documents, clustering of training documents significantly accelerates the classification process.

For example, suppose that, using the methods discussed above, the context miner 26 determines that the target document 16 is likely to be associated with a particular cluster of training documents. For each training document cluster, the context mapper 30 can then correlate, using algorithms disclosed above (e.g. support vector machines), the distribution of features (such as words and phrases) in the summary of that training set with the distribution of those same features in the training document itself.

Using the foregoing correlation, the context mapper 30 assigns weights to selected features of the training document. For example, if a particular feature in the training set is absent from the summary, that feature is accorded a lower weight in the training set. If that feature is also present in the target document 16, then it is likewise assigned a lower weight in the target document 16. Conversely, if a particular feature figures prominently in the summary, that feature, if present in the target document 16, should be accorded a higher weight. In this way, the context mapper 30 effectively reverse engineers the generation of the summary from the training document. Following generation of the weights in the foregoing manner, the context mapper 30 provides the weights to the summary generator 14 for incorporation into the target document 16 prior to generation of the summary.

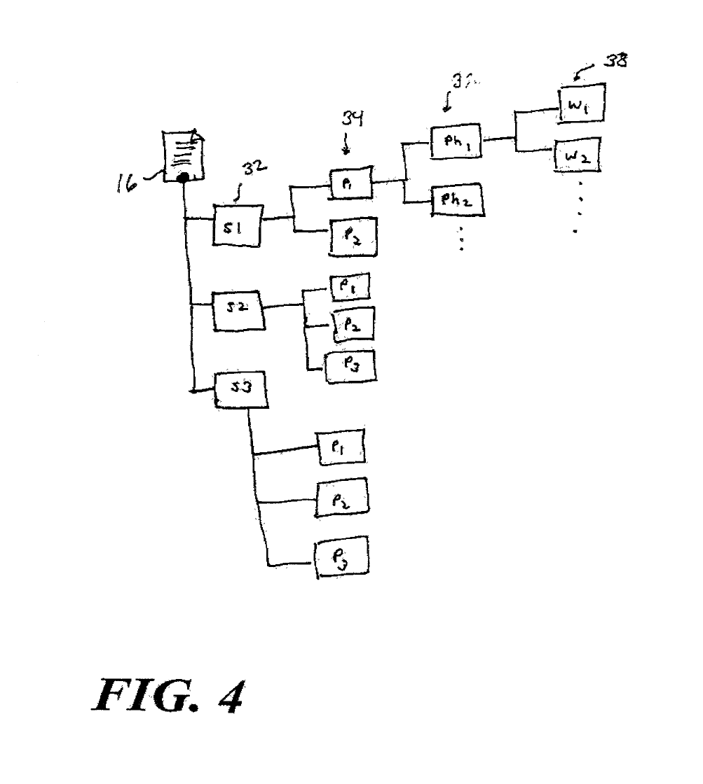

The summary generator 14 lemmatizes the target document 16 by using known techniques of morphological analysis and name recognition. Following lemmatization, the summarizer 14 parses the target document 16 into a hierarchical document tree 31, as shown in FIG. 4. Each node in the document tree 31 corresponds to a document feature that can be assigned a weight. Beginning at the root node, the illustrated document tree 31 includes a section layer 32, a paragraph layer 34, a phrase layer 36, and a word layer 38. Each node is tagged to indicate its linguistic features, such as morphological, syntactic, semantic, and discourse features as it appears in the target document 16.

The total weights generated are a function of both the contextual information generated by the context mapper 30 and by document internal semantic content information as determined by analysis performed by the summary generator 14. This permits different occurrences of a feature to be assigned different weights depending on where those occurrences appear in the target document 16.

In an exemplary implementation, the summary generator 14 descends the document tree 31 and assigns a weight to each node using the following algorithm:

document_weight = 1;
for each constituent in tree

if constituent is a lemma,

then

L = lemma_weight

else

L = 1

endif;
if constituent is in a weighted position,

then

P = position weight

else

P = 1

endif;
weight_of_constituent = weight_of parent * L*P

The summary generator 14 next annotates each node of the document tree 31 with a tag containing information indicative of the weight to be assigned to that node. By weighting the nodes in this manner, it becomes convenient to generate summaries of increasing levels of detail. This can be achieved by selecting a weight threshold and ignoring nodes having a weight below that weight threshold when generating the summary. The summary selector 17 uses the weights on the nodes to determine the most suitable summary based on a given weight threshold.

The process of annotating the target document 16 can be efficiently carried out by tagging selected features of the target document 16. Each such tag includes information indicative of the weight to be assigned to the tagged feature. The annotation process can be carried out by sentential parsers, discourse parsers, rhetorical structure theory parsers, morphological analyzers, part-of-speech taggers, statistical language models, and other standard automated linguistic analysis tools.

The annotated target document and a user-supplied percentage of the target document or some other limit on length (such as limit on the number of words) are provided to the summary selector 17. From the user-supplied percentage or length limit, the summary selector 17 determines a weight threshold. The summary selector 17 then proceeds through the document tree layer by layer, beginning with the root node. As it does so, it marks each feature with a display flag. If a particular feature has a weight higher than the weight threshold, the summary selector 17 flags that feature for inclusion in the completed summary. Otherwise, the summary selector 17 flags that feature such that it is ignored during the summary generation process that follows.

Following the marking process, the summary selector 17 smoothes the marked features into intelligible text by marking additional features for display. For example, the summary selector 17 can mark the subject of a sentence for display when the predicate for that sentence has also been marked for display. This results in the formation of minimally intelligible syntactic constituents, such as sentences. The summary selector 17 then reduces any redundancy in the resulting syntactic constituents by unmarking those features that repeat words, phrases, concepts, and relationships (for example, as determined by a lexical semantic network, such as WordNet) that have appeared in the linearly preceding marked features. Finally, the summary selector 17 displays the marked features in a linear order.

While this specification has described one embodiment of the invention, it is not intended that this embodiment limit the scope of the invention. Instead, the scope of the invention is to be determined by the appended claim.

Having described the invention, and a preferred embodiment thereof, what we claim as new and secured by Letters Patent is:

1. A method for automatically summarizing a target document having a plurality of features, the method comprising:
collecting contextual data external to said document;
on the basis of said contextual data, weighting each of said features from said plurality of features with a weight indicative of the relative importance of that feature, thereby generating a weighted target document; and
generating a summary of said weighted target document.

2. The method of claim 1, wherein collecting contextual data comprises collecting meta-data associated with said target document.

3. The method of claim 1, wherein collecting contextual data comprises collecting user data associated with a user for which a summary of said target document is intended.

4. The method of claim 1, wherein collecting contextual data comprises collecting data from a network containing said target document.

5. The method of claim 4, wherein collecting contextual data comprises collecting data selected from a group consisting of:
a file directory structure containing said target document,
a classification of said target document in a topic tree,
a popularity of said target document,
a popularity of the documents similar to said target document,
a number of hyperlinks pointing to said target document;
the nature of the documents from which hyperlinks pointing to said target document originate,
the size, revision history, modification date, file name, author, file protection flags, and creation date of said target document,
information about an author of said target document author,
domains associated with other viewers of said target document, and
information available in a file external to said target document.

6. The method of claim 1, wherein weighting each of said features comprises:
maintaining a set of training documents, each of said training documents having a corresponding training document summary;
identifying a document cluster from said set of training documents; said document cluster containing training documents that are similar to said target document;
determining, on the basis of training document summaries corresponding to training documents in said document cluster, a set of weights used to generate said training document summaries from said training documents in said document cluster.

7. The method of claim 6, wherein identifying a document cluster comprises identifying a document cluster that contains at most one training document.

8. The method of claim 6, wherein identifying a document cluster comprises comparing a word distribution metric associated with said target document with corresponding word distribution metrics from said training documents.

9. The method of claim 6, wherein identifying a document cluster comprises comparing a lexical distance between said target document and said training documents.

10. A computer-readable medium having, encoded thereon, software for automatically summarizing a target document having a plurality of features, said software comprising instructions for:
collecting contextual data external to said document;
on the basis of said contextual data, weighting each of said features from said plurality of features with a weight indicative of the relative importance of that feature, thereby generating a weighted target document; and
generating a summary of said weighted target document.

11. The computer-readable medium of claim 10, wherein said instructions for collecting contextual data comprise instructions for collecting meta-data associated with said target document.

12. The computer-readable medium of claim 10, wherein said instructions for collecting contextual data comprise instructions for collecting user data associated with a user for which a summary of said target document is intended.

13. The computer-readable medium of claim 10, wherein said instructions for collecting contextual data comprise instructions for collecting data from a network containing said target document.

14. The computer-readable medium of claim 13, wherein said instructions for collecting contextual data comprise instructions for collecting data selected from a group consisting of:
a file directory structure containing said target document,
a classification of said target document in a topic tree,
a popularity of said target document,
a popularity of the documents similar to said target document,
a number of hyperlinks pointing to said target document;
the nature of the documents from which hyperlinks pointing to said target document originate,
the size, revision history, modification date, file name, author, file protection flags, and creation date of said target document,
information about an author of said target document author,
domains associated with other viewers of said target document, and
information available in a file external to said target document.

15. The computer-readable medium of claim 10, wherein said instructions for weighting each of said features comprise instructions for:
maintaining a set of training documents, each of said training documents having a corresponding training document summary;
identifying a document cluster from said set of training documents; said document cluster containing training documents that are similar to said target document;
determining, on the basis of training document summaries corresponding to training documents in said document cluster, a set of weights used to generate said training document summaries from said training documents in said document cluster.

16. The computer-readable medium of claim 15, wherein said instructions for identifying said document cluster comprise instructions for identifying a document cluster that contains at most one training document.

17. The computer-readable medium of claim 15, wherein said instructions for identifying a document cluster comprise instructions for comparing a word distribution metric associated with said target document with corresponding word distribution metrics from said training documents.

18. The computer-readable medium of claim 15, wherein said instructions for identifying a document cluster comprise instructions for comparing a lexical distance between said target document and said training documents.

19. A system for automatically generating a summary of a target document, said system comprising:
a context analyzer having access to information external to said target document; and
a summary generator in communication with said context analyzer for generating a document summary based, at least in part, on said information external to said target document.

20. The system of claim 19, wherein said context analyzer comprises a context aggregator for collecting external data pertaining to said target document.

21. The system of claim 21, wherein said context analyzer further comprises a context miner in communication with said context aggregator, said context miner being configured to classify said target document at least in part on the basis of information provided by said context aggregator.

22. The system of claim 21, wherein said context analyzer further comprises a training-data set containing training documents and training document summaries associated with each of said training documents, and
a context mapper for assigning weights to features of said target document on the basis of information from said training-data set and information provided by said context miner.
